(19) United States
(12) Patent Application Publication
(10) Pub. No.: US 2022/0088971 A1
(43) Pub. Date: Mar. 24, 2022

(54) TIRE

(71) Applicant: SUMITOMO RUBBER INDUSTRIES, LTD., HYOGO (JP)

(72) Inventors: MADOKA HOSHINO, Hyogo (JP); YUICHI ISHIGAKI, Hyogo (JP)

(73) Assignee: SUMITOMO RUBBER INDUSTRIES, LTD., HYOGO (JP)

(21) Appl. No.: 17/468,700

(22) Filed: Sep. 8, 2021

(30) Foreign Application Priority Data
Sep. 23, 2020 (JP) 2020-158827

(51) Int. Cl. B60C 11/12; B60C 11/03

(52) U.S. Cl. CPC B60C 11/1218; B60C 11/0306; B60C 2011/129; B60C 2011/1209; B60C 11/1281

(57) ABSTRACT

The disclosure improves the wear resistance without impairing the on-ice performance. A tire is provided with a block divided by a lateral groove on a ground-contacting part. The block is provided with a plurality of sipes. The plurality of sipes are arranged in a thickness direction of the sipes. Each sipe has a pair of sipe walls that are separated in the thickness direction. Each sipe includes a protrusion that protrudes in a taper shape from one toward the other of the pair of sipe walls.

### CROSS-REFERENCE TO RELATED APPLICATION

This application claims the priority benefit of Japan application serial no. 2020-158827, filed on Sep. 23, 2020. The entirety of the above-mentioned patent application is hereby incorporated by reference herein and made a part of this specification.

### BACKGROUND

### Technical Field

The disclosure relates to a tire.

### Description of Related Art

Patent Document 1 below describes a pneumatic tire in which sipes are formed on a ground-contacting part. On at least one surface of groove wall surfaces of the sipe, protrusions that come into contact with the other opposite surface are formed. It is said that this type of protrusion contacts the opposite wall surface when the ground-contacting part touches the road surface to suppress the displacement between the wall surfaces and suppresses uneven wear.

### RELATED ART

### Patent Document

[Patent Document 1] Japanese Laid-open No. H11-105512

For example, in order to improve on-ice performance, winter studless tires and the like are provided with a plurality of sipes in blocks divided by lateral grooves. Each of the sipes is arranged in the thickness direction thereof. In recent years, in such tires, it has been required to suppress wear of the blocks.

### SUMMARY

The disclosure has been made in view of the above circumstances, and provides a tire capable of improving the wear resistance without impairing the on-ice performance.

The disclosure provides a tire including a tread part. The tread part includes a ground-contacting part. The ground-contacting part is provided with a plurality of blocks divided by a lateral groove. At least one of the plurality of blocks is provided with a plurality of sipes. The plurality of sipes are arranged in a thickness direction of the sipes. Each of the plurality of sipes includes a pair of sipe walls that are separated in the thickness direction, and includes a protrusion that protrudes in a taper shape from one toward the other of the pair of sipe walls.

In the tire according to the disclosure, the pair of sipe walls include a first sipe wall on one side in the thickness direction and a second sipe wall on the other side in the thickness direction, and the protrusion of each of the plurality of sipes protrudes from the first sipe wall toward the second sipe wall.

In the tire according to the disclosure, it is preferable that a cross-sectional area of the protrusion is greater than or equal to 1 mm².

In the tire according to the disclosure, it is preferable that the protrusion is provided on only one of the pair of sipe walls.

In the tire according to the disclosure, it is preferable that the protrusion is provided on both of the pair of sipe walls.

In the tire according to the disclosure, it is preferable that a cross section of the protrusion is circular.

In the tire according to the disclosure, it is preferable that a ratio (Sb/Sa) of a minimum cross-sectional area Sb of the protrusion to a maximum cross-sectional area Sa of the protrusion is 0.5 to 0.8.

In the tire according to the disclosure, it is preferable that a plurality of the protrusions are provided on one of the pair of sipe walls.

### Effects

The tire of the disclosure is capable of improving the wear resistance without impairing the on-ice performance by adopting the above configurations.

### BRIEF DESCRIPTION OF THE DRAWINGS

FIG. 1 is an enlarged plan view showing an embodiment of a tread part of a tire of the disclosure.

FIG. 2 is a cross-sectional perspective view taken along the line A-A of FIG. 1.

In FIG. 3, (a) is a cross-sectional view of the sipe of this embodiment, and (b) is a cross-sectional view of the sipe of another embodiment.

FIG. 4 is a plan view of the block having the sipe of another embodiment.

FIG. 5 is a plan view of the block having the sipe of still another embodiment.

In FIG. 6, (a) is a perspective view of a part of a vulcanization mold for forming the sipe, and (b) is a cross-sectional view of the knife blade of (a).

In FIG. 7, (a) and (b) are cross-sectional views of the knife blade for describing a method of molding the sipe of the embodiment.

FIG. 8 is a vertical cross-sectional view of the knife blade of another embodiment.

### DESCRIPTION OF THE EMBODIMENTS

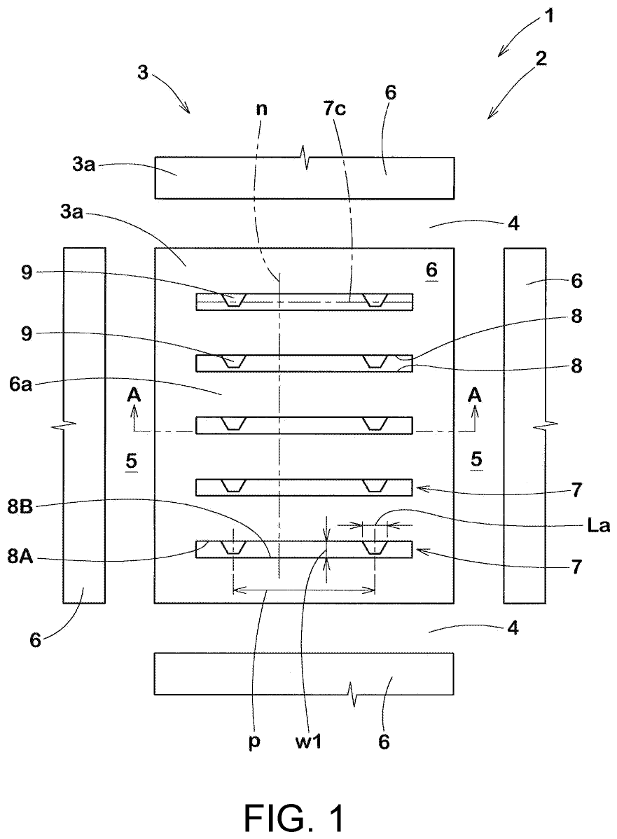

Hereinafter, embodiments of the disclosure will be described with reference to the drawings. FIG. 1 is an enlarged plan view of a tread part 2 of a tire 1 showing an embodiment of the disclosure. The tire 1 of the embodiment is, for example, a pneumatic tire for a passenger vehicle, particularly for a passenger vehicle suitable for running in winter. However, the disclosure is also adopted for pneumatic tires for heavy loads and non-pneumatic tires in which compressed air is not filled.

As shown in FIG. 1, the tread part 2 of the embodiment is provided with a ground-contacting part 3 and a lateral groove 4. Further, the tread part 2 may be provided with, for example, a vertical groove 5. The ground-contacting part 3 has a tread surface 3a in contact with the road surface. The lateral groove 4 extends in the tire axial direction. The vertical groove 5 extends in the tire circumferential direction. In the disclosure, “extending in the tire axial direction” means extending at an angle of less than or equal to 45 degrees with respect to the tire axial direction. Further, “extending in the tire circumferential direction” means extending at an angle of greater than 45 degrees with respect to the tire axial direction.

The ground-contacting part 3 of the embodiment is provided with a plurality of blocks 6 divided by the lateral groove 4. The blocks 6 are arranged, for example, in the tire circumferential direction. In addition, the blocks 6 may be arranged in the tire axial direction. In the embodiment, the block 6 is divided by a pair of lateral grooves 4 separated in the tire circumferential direction and a pair of vertical grooves 5 separated in the tire axial direction. In addition, the block 6 is not limited to such an implementation, and various implementations are adopted.

At least one of the plurality of blocks 6 is provided with a plurality of sipes 7. In the disclosure, the sipe 7 is a notched recess having a width w1 of less than or equal to 1.5 mm, and can be clearly distinguished from the lateral groove 4 and the vertical groove 5 having a groove width of greater than 1.5 mm. Further, the plurality of sipes 7 means two or more sipes 7, and for example, about two to five sipes 7 are preferable.

Unless otherwise specified, the dimensions and the like of each part of the tire 1 are values measured in a regular state. The “regular state” is a no-load state in which the tire 1 is rim-assembled on a regular rim (not shown) and is filled with a regular internal pressure.

The “regular rim” is a rim defined for each tire in a standard system including a standard on which the tire 1 is based, and is, for example, a standard rim in the case of JATMA, a “Design Rim” in the case of TRA, and a “Measuring Rim” in the case of ETRTO.

The “regular internal pressure” is an air pressure defined for each tire in a standard system including a standard on which the tire 1 is based, and is the maximum air pressure in the case of JATMA, the maximum value described in the “TIRE LOAD LIMITS AT VARIOUS COLD INFLATION PRESSURES” table in the case of TRA, and the “INFLATION PRESSURE” in the case of ETRTO.

The plurality of sipes 7 are arranged in a thickness direction (width direction) of the sipes 7. As a result, the block 6 exhibits a high edge effect and has excellent on-ice performance. In the disclosure, the “thickness direction” is a direction orthogonal to a center line 7c of the sipe 7. Being “arranged in the thickness direction” means that other sipes 7 are arranged on a virtual straight line n orthogonal to the center line 7c of one sipe 7.

Each sipe 7 has a pair of sipe walls 8 that are separated in the thickness direction. The pair of sipe walls 8 include a first sipe wall 8A on one side in the thickness direction (upper side in the drawing) and a second sipe wall 8B on the other side in the thickness direction (lower side in the drawing).

Each sipe 7 includes a protrusion 9 that protrudes in a taper shape from one toward the other of the pair of sipe walls 8. Such a protrusion 9 is able to immediately contact the other sipe wall 8 when the block 6 touches the ground, suppress a block piece 6a between the sipes 7 from collapsing or slipping, and improve the wear resistance of the block 6 while exhibiting good on-ice performance. Further, since such a protrusion 9 alleviates the impact at the time of touching the ground and suppresses chipping and the like, the wear resistance is further improved. In the embodiment, each protrusion 9 of each sipe 7 protrudes from the first sipe wall 8A toward the second sipe wall 8B.

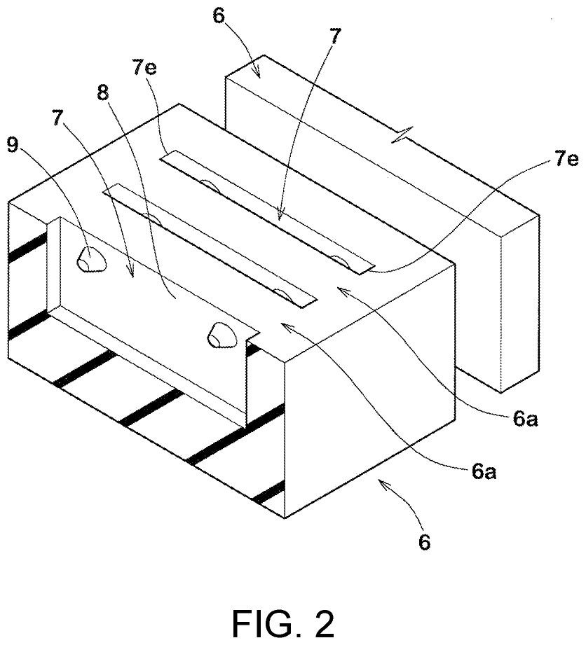

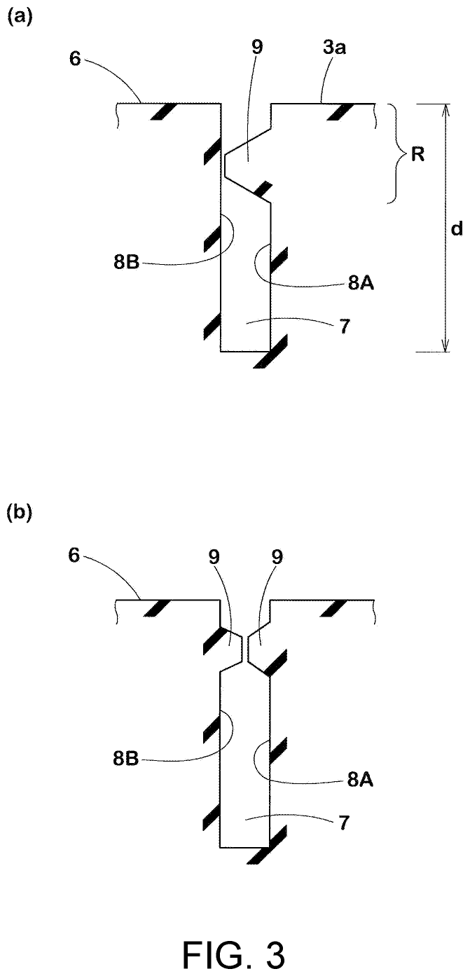

FIG. 2 is a cross-sectional perspective view taken along the line A-A of FIG. 1. (a) of FIG. 3 is a cross-sectional view of the sipe 7. As shown in FIGS. 1 to 3, in the embodiment, the protrusion 9 is provided on only one of the pair of sipe walls 8. The protrusion 9 is provided on, for example, only the first sipe wall 8A. In addition, the protrusion 9 may be provided on only the second sipe wall 8B.

The cross-sectional area S of the protrusion 9 is preferably greater than or equal to 1.0 mm². In this way, the effect of suppressing the collapse of the block 6 is well achieved. The cross-sectional area S of the protrusion 9 is preferably less than or equal to 5.0 mm². If the cross-sectional area S of the protrusion 9 is greater than 5.0 mm², the suction amount of melted water on the ice road into the sipe 7 becomes small, and the on-ice performance may deteriorate. From this point of view, the cross-sectional area S of the protrusion 9 is preferably greater than or equal to 1.5 mm², and preferably less than or equal to 3.5 mm². The protrusion 9 is required to have a maximum cross-sectional area Sa of greater than or equal to 1.0 mm².

The ratio (Sb/Sa) of the minimum cross-sectional area Sb of the protrusion 9 to the maximum cross-sectional area Sa of the protrusion 9 is preferably 0.5 to 0.8. Since the ratio (Sb/Sa) is greater than or equal to 0.5, the collapse of the block is suppressed. Since the ratio (Sb/Sa) is less than or equal to 0.8, a high suction amount of the water is ensured. In the embodiment, the maximum cross-sectional area Sa is formed on the first sipe wall 8A. In other words, the maximum cross-sectional area Sa is formed at the base of the protrusion 9. In the embodiment, the minimum cross-sectional area Sb is formed closest to the second sipe wall 8B side on the protrusion 9. In other words, the minimum cross-sectional area Sb is formed at the tip of the protrusion 9.

A plurality of the protrusions 9 are provided on, for example, one sipe wall 8. In this way, the collapse of the block 6 may be further suppressed. In the embodiment, each protrusion 9 is provided on only the first sipe wall 8A. Two protrusions 9 are provided on the first sipe wall 8A.

The ratio (p/La) of the pitch p between the protrusions 9 to the length La of the protrusion 9 is preferably greater than or equal to 2, more preferably greater than or equal to 4, and preferably less than or equal to 10, and more preferably less than or equal to 6. In this way, the wear resistance and the on-ice performance are improved in a well-balanced manner. The length La of the protrusion 9 is the length along the longitudinal direction of the sipe 7.

The cross section of the protrusion 9 is, for example, circular. In the embodiment, the protrusion 9 has a substantially truncated cone shape. In this way, since the rigidity of the protrusion 9 can be maintained high, good wear resistance can be exhibited. In the disclosure, the term “circular” includes a circular shape or an elliptical shape. In the embodiment, the cross section of the protrusion 9 is formed in an elliptical shape. The cross section of the protrusion 9 is, for example, an elliptical shape whose major axis is arranged parallel to the longitudinal direction of the sipe 7. In addition, the protrusion 9 may have an elliptical shape whose major axis is arranged parallel to the depth direction of the sipe 7 (not shown).

In the embodiment, the protrusion 9 is provided on the tread surface 3a side with respect to the bottom of the sipe 7. In this way, when the block 6 touches the ground, the collapse or slippage of the block piece 6a may be firmly suppressed. From this point of view, it is preferable that the disposition position of the protrusion 9 is in a region R of 25% of the depth d of the sipe 7 from the tread surface 3a to the bottom side of the sipe 7.

In the embodiment, each sipe 7 extends in the tire axial direction. Each sipe 7 extends, for example, parallel to the lateral groove 4. In each sipe 7, for example, ends 7e on both sides are arranged within the block 6. Each sipe 7 is not limited to such an implementation, and may cross the block 6, or may have only one end 7e arranged within the block 6 (not shown).

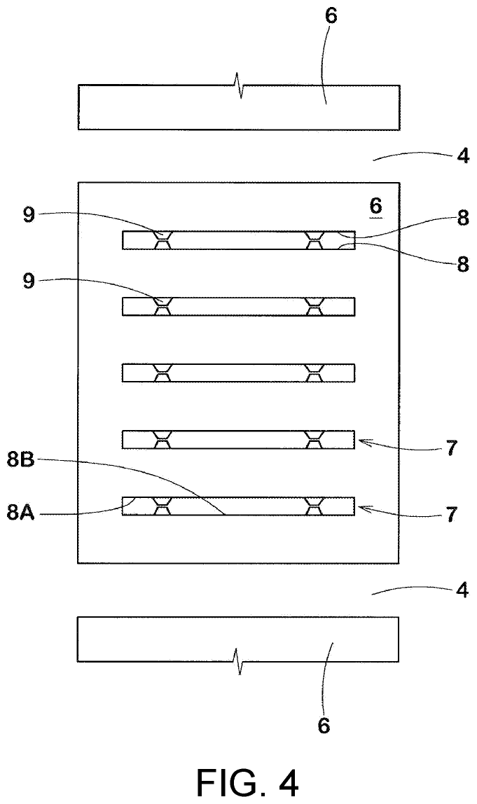

(b) of FIG. 3 is a cross-sectional view of the sipe 7 of another embodiment, and FIG. 4 is a plan view of the block 6 having the sipe 7 of (b) of FIG. 3. The same components as those of the above embodiment are denoted by the same reference numerals, and detailed descriptions thereof will be omitted. As shown in (b) of FIG. 3 and FIG. 4, the block 6 of this embodiment is provided with a plurality of sipes 7 having protrusions 9. The protrusions 9 are provided on both of the pair of sipe walls 8. Even in such an implementation, the collapse of the block 6 between the sipes 7 is suppressed, and the wear resistance is improved.

In this embodiment, the maximum cross-sectional area Sa of the protrusion 9 provided on the first sipe wall 8A is formed greater than the maximum cross-sectional area Sa of the protrusion 9 provided on the second sipe wall 8B. Further, the minimum cross-sectional area Sb of the protrusion 9 provided on the first sipe wall 8A is formed equal to the minimum cross-sectional area Sb of the protrusion 9 provided on the second sipe wall 8B. In addition, the maximum cross-sectional area Sa of the protrusion 9 provided on the first sipe wall 8A may be formed equal to the maximum cross-sectional area Sa of the protrusion 9 provided on the second sipe wall 8B.

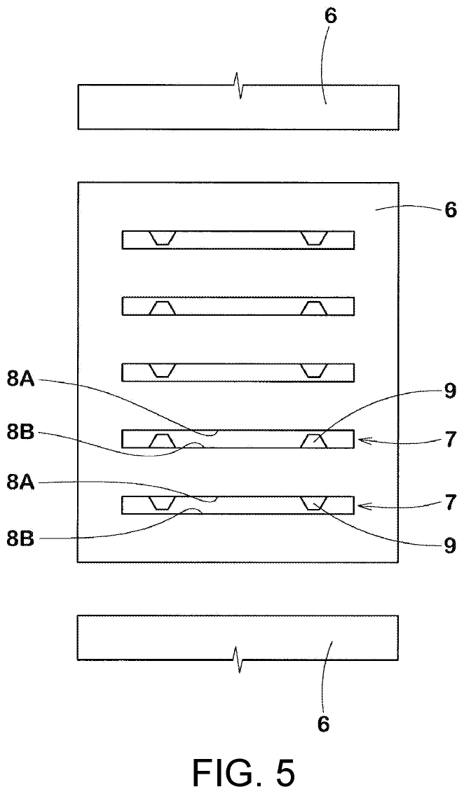

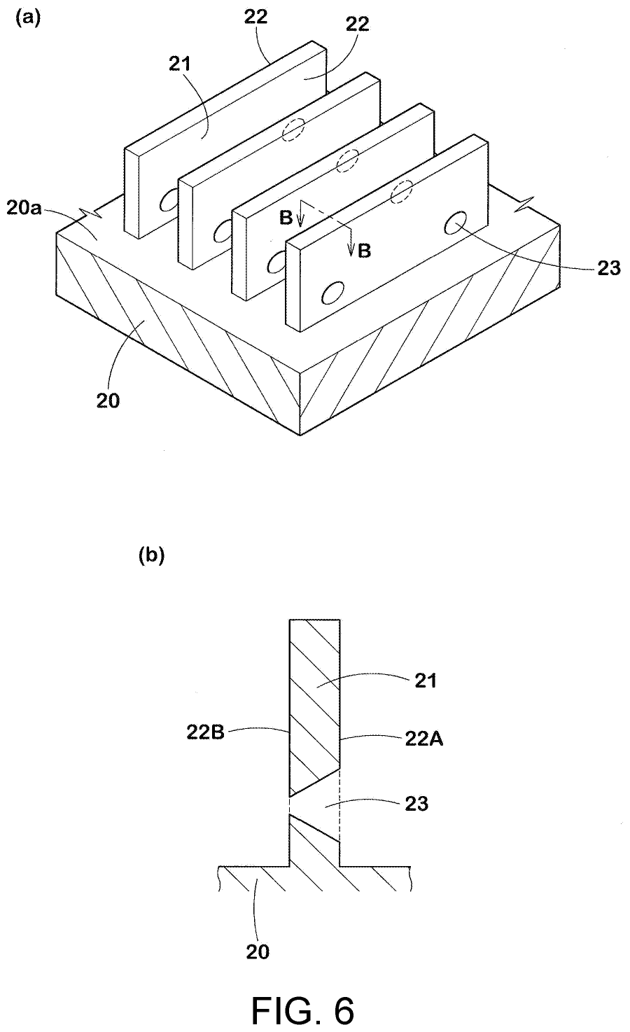

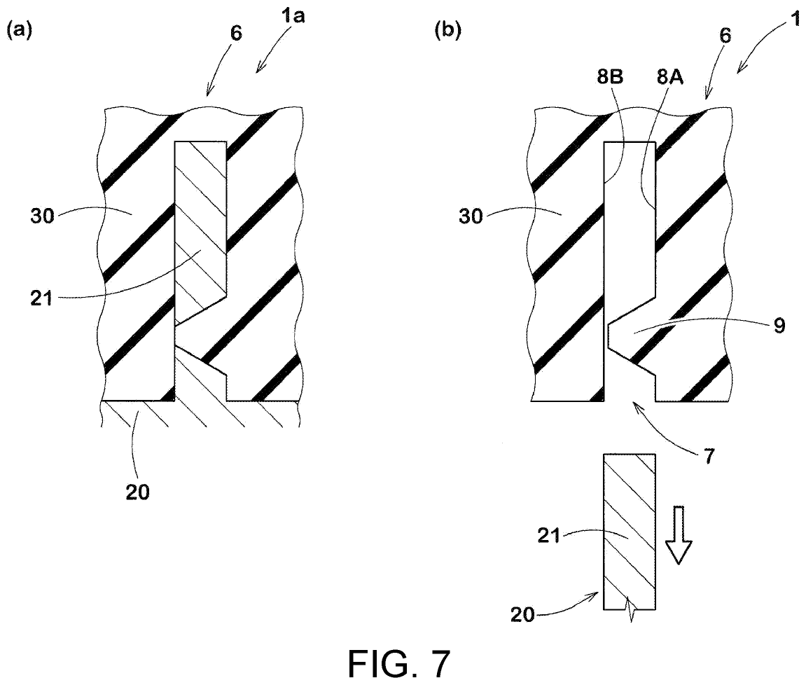

FIG. 5 is a cross-sectional view of the block 6 of still another embodiment. The same components as those of the above embodiment are denoted by the same reference numerals, and detailed descriptions thereof will be omitted. As shown in FIG. 5, in this embodiment, the protrusions 9 provided on the sipes 7 adjacent to each other in the thickness direction are arranged in opposite directions. In other words, the protrusion 9 of one sipe 7 is provided on only the first sipe wall 8A, and the protrusion 9 of another sipe 7 adjacent to the one sipe is provided on only the second sipe wall 8B.

Next, a method for molding such a protrusion 9 will be described. (a) of FIG. 6 is a perspective view of a part of a vulcanization mold 20 for vulcanizing a raw tire 1a (shown in FIG. 7), and (b) of FIG. 6 is a cross-sectional view taken along the line B-B of (a). The tire 1 is formed by vulcanizing the raw tire 1a by using the vulcanization mold 20. As shown in FIG. 6, the vulcanization mold 20 includes a tread molding surface 20a for molding the tread part 2 of the tire 1. The tread molding surface 20a is provided with a thin plate-shaped knife blade 21 for molding the sipe 7. The knife blade 21 protrudes outward from the tread molding surface 20a.

The knife blade 21 of the embodiment has a pair of longitudinal surfaces 22 separated in the width direction and a through hole 23 for forming the protrusion 9. The through hole 23 extends, for example, between the pair of longitudinal surfaces 22.

(a) of FIG. 7 is a cross-sectional view near the knife blade 21 of the raw tire 1a being vulcanized, and (b) of FIG. 7 is a cross-sectional view showing a state where the tire 1 has been detached from the vulcanization mold 20 after vulcanization is completed. As shown in FIG. 7, when the raw tire 1a is put into such a vulcanization mold 20 and an internal pressure is applied, a rubber material 30 forming the block 6 enters the through hole 23. When the vulcanization is completed and the vulcanized tire 1 is separated from the vulcanization mold 20, the rubber material 30 that has entered the through hole 23 is cut by the knife blade 21 to form the protrusion 9.

In order to form the protrusion 9 of the embodiment as shown in FIG. 2, as shown in (b) of FIG. 6, the through hole 23 has a continuously smaller cross-sectional area from one longitudinal surface 22A toward the other longitudinal surface 22B, and has a circular cross section. In other words, the through hole 23 is formed in a truncated cone shape. The ratio (Sd/Sc) of the opening area Sd of the through hole 23 on the other longitudinal surface 22B to the opening area Sc of the through hole 23 on the one longitudinal surface 22A is, for example, preferably greater than or equal to 0.5, more preferably greater than or equal to 0.6, and preferably less than or equal to 0.8, and more preferably less than or equal to 0.7.

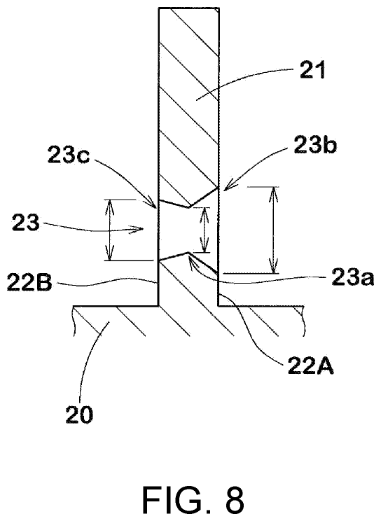

FIG. 8 is a cross-sectional view of the knife blade 21 for forming the protrusion 9 as shown in (b) of FIG. 3. As shown in FIG. 8, the through hole 23 arranged in the knife blade 21 of this embodiment has a minimum opening 23a, which has a minimum opening area, formed between the one longitudinal surface 22A and the other longitudinal surface 22B. Further, the through hole 23 of this embodiment has a maximum opening 23b, which has a maximum opening area, on the one longitudinal surface 22A. Further, the through hole 23 has an intermediate opening 23c, which has an opening area less than or equal to that of the maximum opening 23b and greater than that of the minimum opening 23a, on the other longitudinal surface 22B. In such a through hole 23, the rubber material 30 is cut at the minimum opening 23a.

In this embodiment, the opening area of the minimum opening 23a is preferably greater than or equal to 0.5 times, more preferably greater than or equal to 0.6 times, the opening area of the maximum opening 23b, and preferably less than or equal to 0.8 times, more preferably less than or equal to 0.7 times, the opening area of the maximum opening 23b. The opening area of the minimum opening 23a is preferably greater than or equal to 0.5 times, more preferably greater than or equal to 0.6 times, the opening area of the intermediate opening 23c, and preferably less than or equal to 0.8 times, more preferably less than or equal to 0.7 times, the opening area of the intermediate opening 23c.

Although the particularly preferable embodiments of the disclosure have been described in detail above, the disclosure is not limited to the illustrated embodiments, and may be modified into various implementations.

### Example

Sample tires having the block shown in FIG. 1 were manufactured. Then, the wear resistance and the on-ice performance of each sample tire were tested. The common specifications and test methods for each sample tire are as follows.

Tire size: 205/55R16

Rim size: 16×7.0

Knife blade width (thickness): 0.6 mm

Number of sipes of block: 2

<Wear Resistance>

Each sample tire was mounted on all wheels of a passenger vehicle under the following conditions. Then, after the test driver actually ran the vehicle on a test course on a dry asphalt road surface, the wear condition of the block provided with the sipes was evaluated by senses. The results are shown with a score of 100 for the comparative example. The greater the value, the smaller the wear amount and the better the wear resistance.

Running distance: 20000 km

Internal pressure: 230 kPa

<On-Ice Performance>

Using the above test vehicle, the test driver actually ran the vehicle on a test course on an icy road surface, and evaluated the properties related to stability and ease of running at that time by senses. The results are shown with a score of 100 for the comparative example. The greater the value, the better the on-ice performance. The test results are shown in Table 1.

TABLE 1

| | Comparative | | | | | | | | |
|---|---|---|---|---|---|---|---|---|---|
| | example | Example 1 | Example 2 | Example 3 | Example 4 | Example 5 | Example 6 | Example 7 | Example 8 |
| Shape of protrusion | Circular | Taper | Taper | Taper | Taper | Taper | Taper | Taper | Taper |
| | column | (truncated | (truncated | (truncated | (truncated | (truncated | (truncated | (truncated | (truncated |
| | | cone) | cone) | cone) | cone) | cone) | cone) | cone) | cone) |
| Figure showing | FIG. 1 | FIG. 1 | FIG. 1 | FIG. 1 | FIG. 1 | FIG. 1 | FIG. 1 | FIG. 5 | FIG. 1 |
| arrangement of | | | | | | | | | |
| protrusion | | | | | | | | | |
| Cross-sectional | 1.5 | 1.5 | 3.0 | 1.5 | 1.5 | 1.5 | 1.5 | 1.5 | 0.78 |
| area S (mm [symbol] ) | | | | | | | | | |
| of protrusion | | | | | | | | | |
| Sb/Sa (times) | 1.0 | 0.6 | 0.6 | 0.4 | 0.5 | 0.8 | 0.9 | 0.6 | 0.6 |
| Wear resistance | 100 | 120 | 125 | 110 | 120 | 120 | 125 | 115 | 110 |
| [score: the greater | | | | | | | | | |
| the better] | | | | | | | | | |
| On-ice performance | 100 | 110 | 100 | 115 | 110 | 110 | 100 | 120 | 110 |
| [score: the greater | | | | | | | | | |
| the better] | | | | | | | | | |

[symbol]

indicates data missing or illegible when filed

By the tests, it is understood that the tires of the examples are superior in the wear resistance as compared with the tire of the comparative example. It is also understood that the tires of the examples maintain good on-ice performance.

What is claimed is:

1. A tire, comprising:
a tread part,
wherein the tread part comprises a ground-contacting part,
the ground-contacting part is provided with a plurality of blocks divided by a lateral groove,
at least one of the plurality of blocks is provided with a plurality of sipes,
the plurality of sipes are arranged in a thickness direction of the sipes, and
each of the plurality of sipes comprises a pair of sipe walls that are separated in the thickness direction, and comprises a protrusion that protrudes in a taper shape from one toward the other of the pair of sipe walls.

2. The tire according to claim 1, wherein the pair of sipe walls comprise a first sipe wall on one side in the thickness direction and a second sipe wall on the other side in the thickness direction, and
the protrusion of each of the plurality of sipes protrudes from the first sipe wall toward the second sipe wall.

3. The tire according to claim 1, wherein a cross-sectional area of the protrusion is greater than or equal to 1 mm².

4. The tire according to claim 1, wherein the protrusion is provided on only one of the pair of sipe walls.

5. The tire according to claim 1, wherein the protrusion is provided on both of the pair of sipe walls.

6. The tire according to claim 1, wherein a cross section of the protrusion is circular.

7. The tire according to claim 1, wherein a ratio (Sb/Sa) of a minimum cross-sectional area Sb of the protrusion to a maximum cross-sectional area Sa of the protrusion is 0.5 to 0.8.

8. The tire according to claim 1, wherein a plurality of the protrusions are provided on one of the pair of sipe walls.
